(19) United States
(12) Patent Application Publication
(10) Pub. No.: US 2021/0169616 A1
(43) Pub. Date: Jun. 10, 2021

(54) METHOD OF PRODUCING AND DEPLOYING ORTHODONTIC BRACKETS OR ATTACHMENTS

(71) Applicant: CA DIGITAL GmbH, Hilden (DE)

(72) Inventor: Yong-Min Jo, Hilden (DE)

(21) Appl. No.: 16/770,669

(22) PCT Filed: Dec. 10, 2018
(86) PCT No.: PCT/EP2018/084222

§ 371 Date: Jun. 8, 2020

(30) Foreign Application Priority Data
Dec. 8, 2017 (GB) 1720467.8

(51) Int. Cl. A61C 7/14; A61C 7/00; A61C 13/34; A61C 9/00

(52) U.S. Cl. CPC A61C 7/146; A61C 9/0006; A61C 13/34; A61C 7/002

(57) ABSTRACT

The present invention relates to methods of producing and deploying orthodontic brackets (2a) or attachments.

### FIELD OF THE INVENTION

The present invention relates to methods of producing and deploying orthodontic brackets or attachments.

### BACKGROUND

The field of orthodontics has undergone a dramatic technological change in the past 20 years. Digital technologies including scanning of moulds or imprints, computer aided manipulation of teeth in a 3D digital model, and rapid prototyping/3D printing of setups for later vacuum forming of aligners have replaced the conventional approach of using plaster cards, and manipulating the tooth model by means of a saw and wax sockets.

However, the production and deployment of orthodontic brackets and attachment still follows conventional pathways. Usually, brackets, which accommodate an archwire to exert correctional forces, and attachments, which fit into complimentary cavities of correctional aligners, are off-the-shelf-products that do not allow any patient specific individualization.

Sometimes, attachments are made from the polymerizable material which is filled into the respective cavities and cured e.g. by application of ultraviolet light, in situ. However, this is a laborious process. Such methods of in situ curing of attachments are disclosed in EP1143872A1.

It is hence one object of the present provide means and methods to allow the individualized production of brackets and attachments for orthodontic use.

It is one further object of the present invention to facilitate the production of orthodontic brackets and attachments.

It is one further object of the present invention to facilitate the deployment of orthodontic brackets and attachments.

These and further objects are met with methods and means according to the independent claims of the present invention. The dependent claims are related to specific embodiments.

### SUMMARY OF THE INVENTION

The present invention provides methods of producing and deploying orthodontic brackets or attachments. The invention and general advantages of its features will be discussed in detail below.

### BRIEF DESCRIPTION OF THE FIGURES

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

FIG. 1a shows a dentition model 1a comprising a tooth model 3 which has, on its labial surface, an orthodontic bracket 2a connected to the tooth surface via at least one linker structure 4, which is embodied as a predetermined breaking point. The tooth model 3 is supported by a model of a patient's jaw ridge 7.

The dentition model including the bracket has been created by a CAM method. The bracket can be released from the tooth model by breaking, cleaving or dissolving the linker structure.

FIG. 1b shows a dentition model 1b comprising a tooth model 3 which has, on its labial surface, an orthodontic attachment 2b connected to the tooth surface via at least one linker structure 4, which is embodied as a predetermined breaking point. The tooth model 3 is supported by a model of a patient's jaw ridge 7.

FIG. 1c shows a dentition model 1c comprising a tooth model 3 which has, on its labial surface, an orthodontic attachment 2c connected to the tooth surface via at least one linker structure 4, which is embodied as a predetermined breaking point. The tooth model 3 is supported by a model of a patient's jaw ridge 7. The orthodontic attachment comprises 2c has a conduit 21 that serves to accommodate an archwire. The attachment is shown in more detail in FIG. 8.

The dentition model including the attachment has been created by a CAM method. The attachment can be released from the tooth model by breaking, cleaving or dissolving the linker structure.

It goes without saying that the bracket or attachment as shown in FIGS. 1a and 1b can also be arranged on the palatal surfaces of the teeth of the patient.

FIG. 2 shows a negative model 5 of the dentition model 1a or 1b which has been created by forming or molding a matrix material over the dentition model including the bracket or attachment, thereby forming cavities 6 which accommodate the bracket or attachment.

The negative model can be used as a transfer tray. It is molded over the tooth model, then the brackets or attachments are released from the tooth model by breaking, cleaving or dissolving the linker structure. Then, the negative model is arranged over a patient's gum or jaw ridge, and brackets or attachments accommodated in the cavities of are attached to one or more labial and/or palatal surfaces of one or more teeth of the patient.

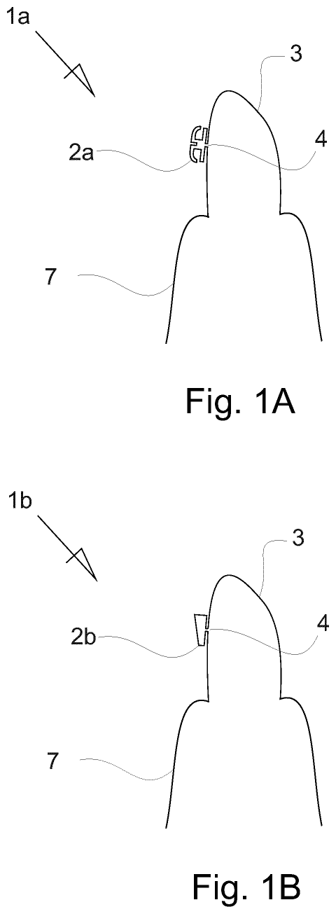

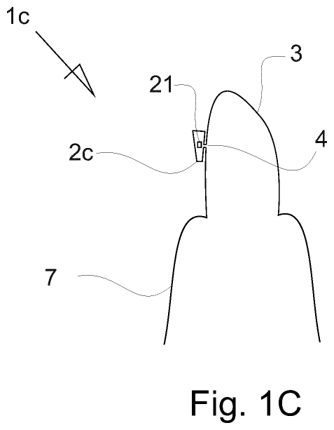

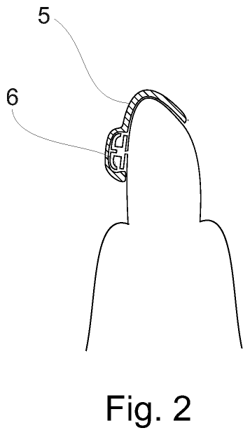

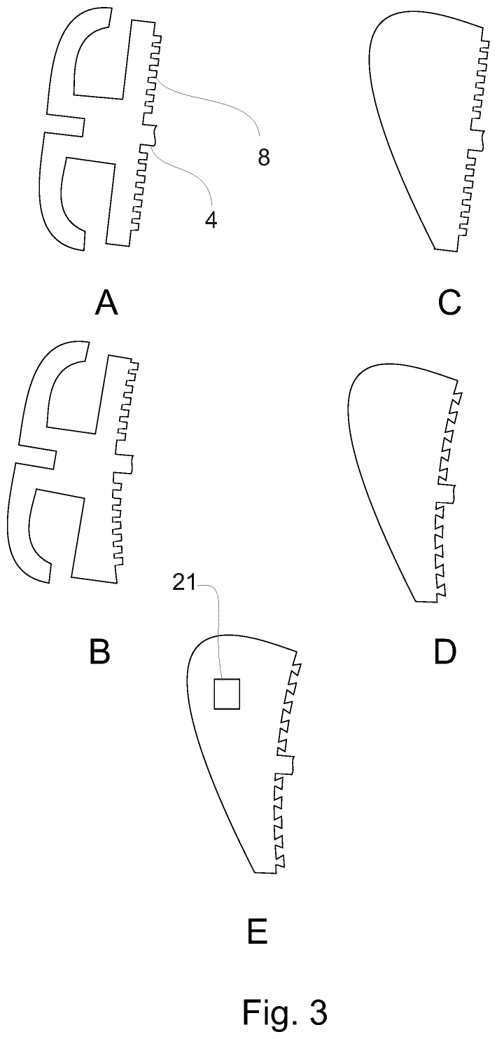

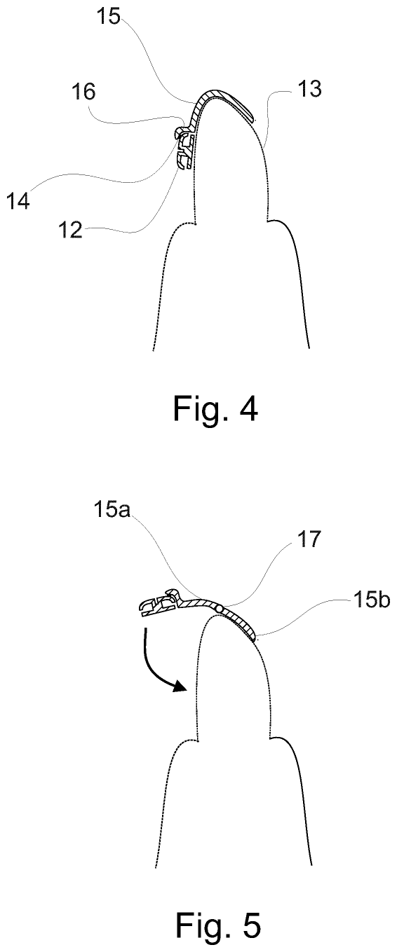

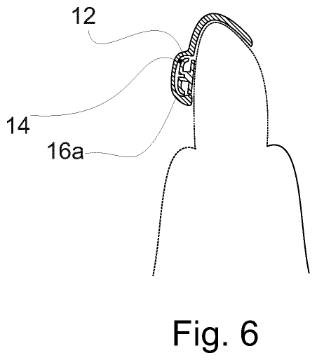

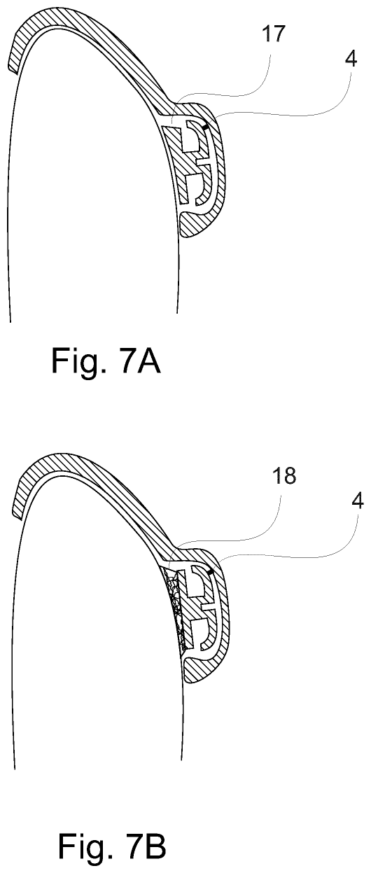

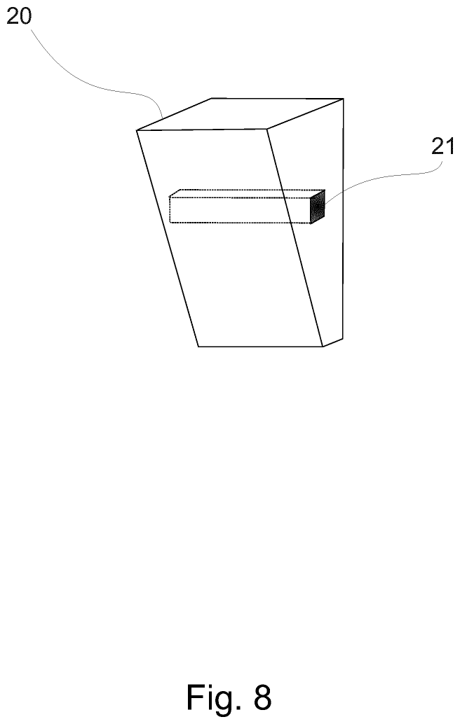

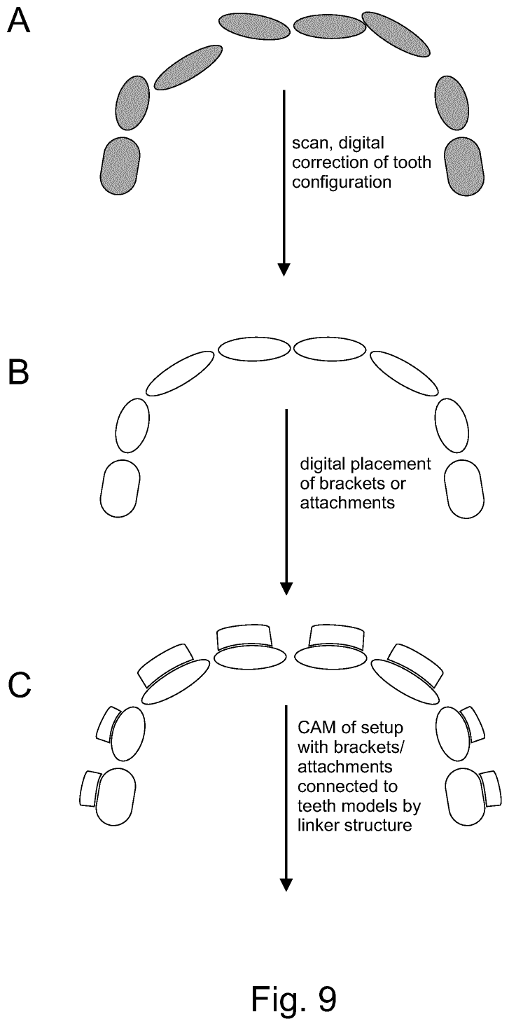

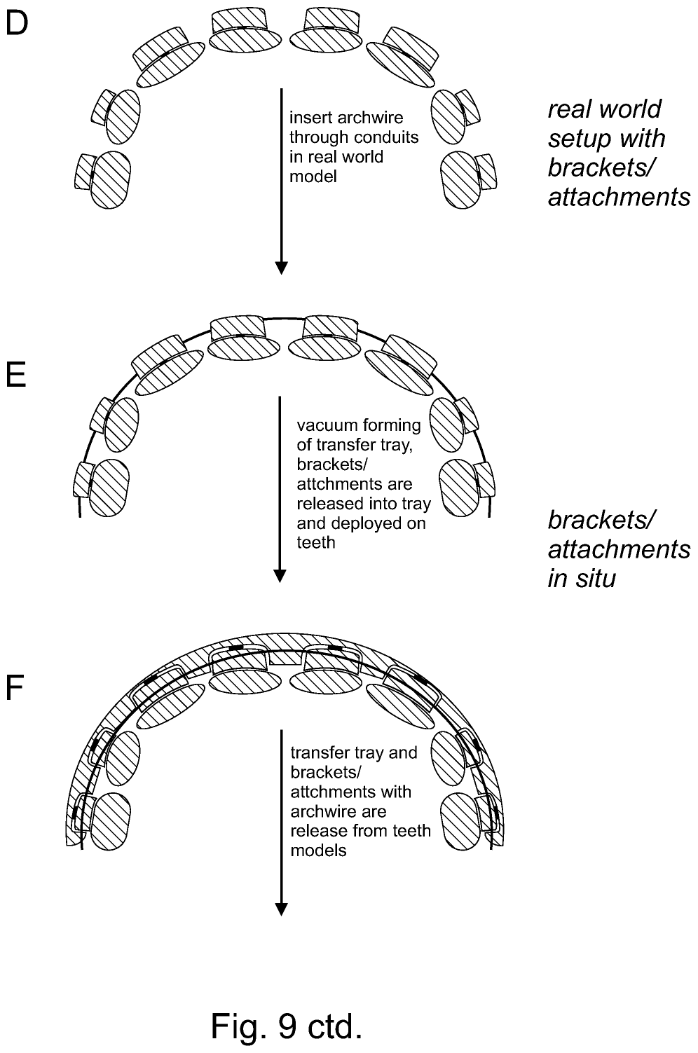

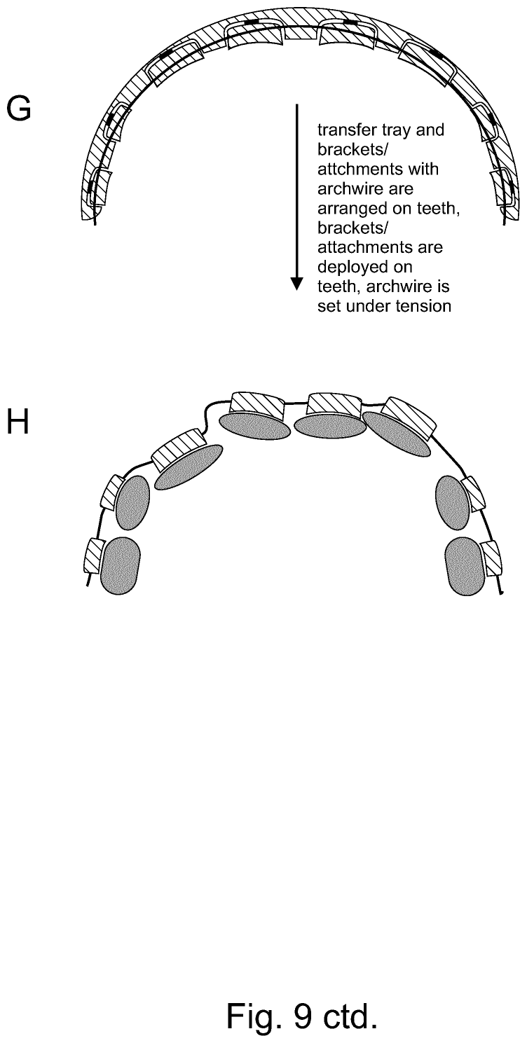

It goes without saying that the bracket or attachment as shown in FIGS. 1a, 1b and 2 can also be arranged on the palatal surfaces of the teeth of the patient.

FIG. 3A shows the cross section of an orthodontic bracket according to the invention after being released from the tooth model, with the remainder of the linker structure 4 and a microstructure 8. Said microstructure facilitates the subsequent fixation of the bracket on the patient's tooth surface, by means of an adhesive, a cement or a curable resin. In the example shown in FIG. 3, the microstructure consists of a pattern of ridges. In like manner, such microstructure can also be made in an orthodontic attachment according to the invention.

FIG. 3B shows a similar embodiment as FIG. 3A, with the exception that the tooth-facing surface of the bracket has an individualized concave shape so as to be form-locking with the part of the tooth it is to be attached to.

FIG. 3C shows a similar embodiment as FIG. 3A, with the exception that an attachment is being shown instead of a bracket. If the FIG. 3D shows a similar embodiment as FIG. 3B, with the exception that an attachment is being shown instead of a bracket.

FIG. 3E shows a similar embodiment as FIGS. 3c and 3D, which has a conduit 21 that serves to accommodate an archwire. The attachment is shown in more detail in FIG. 8.

FIG. 4 shows another aspect of the present invention. A transfer tray for the deployment of one or more orthodontic brackets or orthodontic attachments 12 to one or more teeth 13 of a patient is provided.

The transfer tray comprises a section 15 that is form-locking with at least a part of a crown of at least one tooth 13 of a patient. Further, the tray comprises at least one cavity or recess 16 that accommodates or carries at least one such bracket or attachment 12. The at least one bracket or attachment 12 is connected to the tooth-facing surface of the cavity or recess 16 via at least one linker structure 14. The linker structure is embodied as a predetermined breaking point.

In this embodiment, the transfer tray 15, the linker structure 14 and the bracket or attachment 12 have preferably been made by an integral production method, for example a 3-D printing method or a CNC milling method. Hence, the entire construct can be taken directly from the production machine and arranged on a patient's tooth to deploy the attachment or bracket.

Before the transfer tray is arranged on the tooth, a curable resin is applied onto the tooth surface, or the tooth-facing side of the surface of the bracket or attachment. When the tray is arranged on the tooth, the bracket or attachment comes into contact with the tooth surface via the applied resin, which can then be cured. After the curable resin has been cured, the bracket or attachment remains attached to the tooth in the desired position. When the entire transfer tray is removed from the tooth, the linker structure, which is embodied as a predetermined breaking point, will break.

FIG. 5 shows one preferred embodiment of said aspect. Therein, the section 15 comprises a first subsection 15b which is suitable to be releasably attached to at least a part of a crown of at least one tooth of a patient, and a second subsection 15a which comprises the at least one cavity or recess 16 that accommodates or carries the at least one bracket or attachment 12 connected to the latter by the linker structure 14.

The two subsections are connected to one another by means of an integral hinge 17, in such way that the second subsection 15a can be flipped towards or away from the tooth 13.

The second subsection can hence be flipped away from the tooth. This allows to attach a curable resin onto the tooth surface, or the tooth-facing side of the surface of the bracket or attachment. By flipping the second subsection back to the tooth the bracket or attachment comes into contact with the tooth surface via the applied resin, which can then be cured. After the curable resin has been cured, the bracket or attachment remains attached to the tooth in the desired position. When the second subsection is flipped away, or when the entire transfer tray is removed from the tooth, the linker structure, which is embodied as a predetermined breaking point, will break.

It is important to understand that this specific embodiment, where two subsections of the transfer tray are connected to one another and means of a hinge, so as to facilitate the deployment of an attachment or bracket, can form an independent embodiment, meaning that the orthodontic attachment or bracket does not necessarily have to be connected to the transfer tray or the tooth models by said fixed linker structure. The cavity or recess can be formed in such way that it forms a mould which fully accommodates a prefabricated orthodontic attachment or bracket, or into which a curable resin can be filled which, after flipping the second subsection down, can be cured in situ on the patients tooth.

FIG. 6 shows a similar embodiment as FIG. 4, with the exception that the cavity or recess 16 fully accommodates the bracket or attachment 12 in a form-locking manner. The bracket or attachment is connected to the tooth-facing surface of the cavity or recess 16 via at least one linker structure 14. The linker structure is embodied as a predetermined breaking point.

In this embodiment, the transfer tray can be re-used to re-attach or replace brackets which have been deployed to the tooth but have scaled off during use. It goes without saying, that in the embodiment according to FIG. 5, the transfer tray can be modified in the same way.

FIG. 7A shows an embodiment where the bracket or attachment has a tooth facing side 18 which is shaped to be form locking with the part of the tooth it is to be attached to. Such form-locking surface can be accomplished because the bracket is preferably being produced with a CAM method. In such embodiment, the 3D shapes of the brackets can be highly individualized, thus being modeled as a negative to the surface shape of the section of the tooth to which they are meant to be deployed. This embodiment avoids the use of excess resin, and improves the physical connection between the brackets or attachments and the teeth.

FIG. 7B shows an embodiment where the bracket has no such individualized tooth facing side which is shaped to be form locking with the part of the tooth it is to be attached to. The gaps between the tooth facing surfaces of the brackets and the tooth surfaces are being closed with excess application of curable resin 19. The linker stricture 4 shown in FIG. 7A and FIG. 7B can be absent in case the embodiment of FIGS. 7A and 7B is based on an embodiment where the linker structure is established between the bracket and the tooth model, as shown in FIG. 1

It goes without saying that, in the embodiments according to FIG. 7, an attachment can be used instead of a bracket.

FIG. 8 shows a specific embodiment of an attachment 20 having a conduit 21 that serves to accommodate an archwire, as shown in FIG. 1c. Such attachment can double-act as a bracket, e.g., in a first phase of an orthodontic treatment, where the first steps of tooth correction are being accomplished by means of an archwire, whereas, in a second phase of an orthodontic treatment, the remaining steps of tooth corrections are being accomplished by means of an aligner, which has cavities into which the attachment engages.

It is important to understand that this specific embodiment can form an independent embodiment, meaning that the orthodontic attachment or bracket does not necessarily have to be connected to the transfer tray or the tooth models by said fixed linker structure.

FIG. 9 shows the general features of the processes for producing and orthodontic attachments or records to patient's teeth according to the present invention. Gray shapes mean real teeth of a patient, hollow shapes mean digital objects, and hatched shapes mean objects produced by a CAM method, like e.g. 3-D printing, rapid prototyping or CNC milling.

FIG. 9A shows the “as is” tooth configuration of a patient prior to the onset of the treatment, while FIG. 9B shows the digital model after corrections of the tooth configuration. The corrected tooth configuration, either as a digital model or as a true real world model, is called “setup” herein.

One preferred process is as follows:
a) The “as is” tooth configuration of a patient is digitized by means of an oral scanner or by scanning in a dental impression, or a dental cast, to produce a digital model of the “as is” tooth configuration
b) In a suitable CAD system, the tooth configuration of the digital model is corrected
c) Brackets or attachments are digitally placed on the surfaces of the teeth in the digital model Attachments or brackets comprise conduits that serve to accommodate an archwire, preferably from a shape memory material, like Nitinol
d) A setup with tooth models to which attachment or brackets are connected by means of a linker structure is prepared by a rapid prototyping/CAM method
e) Archwire is inserted into the conduits of the attachments in the setup
f) a transfer tray is produced by vacuum forming of a thermoplastic sheet over the setup, and cavities are formed which accommodate the attachments
g) the attachments are released from the tooth models by breaking, cleaving or dissolving the linker structure, and remain in the cavities of the transfer tray, together with the archwire that is inserted into the conduits of the attachments
h) the transfer tray is arranged on one or more teeth of a patient, and the one or more attachments are attached to the one or more tooth surfaces by means of an adhesive, due to the said transfer process, the archwire is deformed and thus set under pressure, and, after final deployment of the attachments, exerts correcting forces onto the teeth.

In such way, the archwire can be inserted into the attachments in an ex vivo situation, e.g., on the laboratory bench. This is much easier than inserting the archwire into the conduits in an in situ situation (in particular when the attachments are arranged on the palatal surfaces of the teeth of the patient), and hence, reduces treatment costs, and increases patient comfort and compliance.

### DETAILED DESCRIPTION OF THE INVENTION

Before the invention is described in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. It must be noted that, as used in the specification and the appended claims, the singular forms “a”, “an”, and “the” include singular and/or plural referents unless the context clearly dictates otherwise. It is moreover to be understood that, in case parameter ranges are given which are delimited by numeric values, the ranges are deemed to include these limitation values.

It is further to be understood that embodiments disclosed herein are not meant to be understood as individual embodiments which would not relate to one another. Features discussed with one embodiment are meant to be disclosed also in connection with other embodiments shown herein. If, in one case, a specific feature is not disclosed with one embodiment, but with another, the skilled person would understand that does not necessarily mean that said feature is not meant to be disclosed with said other embodiment. The skilled person would understand that it is the gist of this application to disclose said feature also for the other embodiment, but that just for purposes of clarity and to keep the specification in a manageable volume this has not been done.

Furthermore, the content of the prior art documents referred to herein is incorporated by reference. This refers, particularly, for prior art documents that disclose standard or routine methods. In that case, the incorporation by reference has mainly the purpose to provide sufficient enabling disclosure, and avoid lengthy repetitions.

According to a first aspect, a method of producing one or more orthodontic brackets or attachments is provided, the method comprising
i) creating, by a CAM method, a dentition model comprising one or more tooth models, which model has, on its labial and/or palatal surface, at least one bracket or attachment connected on its tooth-facing side to the tooth surface via at least one linker structure (4), which linker structure is embodied as a predetermined breaking point.

In such embodiment, the tooth models, the linker structure and the bracket or attachment are integrally formed by the CAM method.

The term “orthodontic bracket”, as used herein, refers to a bracket that serves to secure an archwire on one or more teeth of a patient.

The term “orthodontic attachment”, as used herein, refers to an attachment bracket that serves to secure an orthodontic aligner, retainer or positioner on one or more teeth of a patient.

The term “CAM”, as used herein, means “computer aided manufacturing”, and refers to methods in which a real world model is created directly out of digital data (CAD data). CAM is sometimes nicknamed “rapid prototyping” or “rapid manufacturing”.

According to one embodiment, the method further comprises
j) releasing the one or more brackets or attachments from the tooth surface by breaking, cleaving or dissolving the linker structure.

According to one further embodiment, a method for transferring one or more orthodontic brackets or attachments from a dentition model, to which they are connected by linker structure, into a transfer tray, is provided, the method comprising, after step a) and before step b), a step
a1.1) in which a transfer tray comprising a negative model of the dentition model is created by forming or molding a matrix material over the dentition model including the one or more brackets or attachments, thereby forming cavities which accommodate the brackets or attachments, or
a1.2) in which transfer tray comprising a prefabricated negative model of the dentition model, which negative model comprises cavities to accommodate the bracket or attachment, is arranged on the dentition model.

According to one further embodiment, after step a1.1) or a1.2), a further step
a2) is provided in which the transfer tray is removed from the dentition model, whereby the one or more brackets or attachments are released from the tooth surface by breaking, cleaving or dissolving the linker structure,
a3) in such way that they remain in the cavities formed in the negative model.

According to one further embodiment, a method of transferring one or more orthodontic brackets or orthodontic attachments from a prefilled transfer tray as produced according to the above description to the one or more teeth of a patient is provided, said method comprising the steps of
k) arranging the transfer tray on one or more teeth of a patient, and
l) attaching the one or more brackets or attachments to the one or more tooth surfaces.

In one embodiment, the method according to the invention comprises steps a), a1), a2), a3) b), c) and d)

According to one further embodiment, the method further comprises a step in which the negative model is formed by vacuum forming of a thermoplastic sheet over the dentition model.

Such methods of vacuum forming are for example disclosed in McNamara & Brudon (1993), the content of which is fully incorporated herein by reference.

According to one embodiment, the dentition model further comprises a model of a patient's gum or jaw ridge, or of a fragment thereof, which supports the one or more tooth models.

According to one further embodiment of the invention, a method of producing a prefilled transfer tray for the deployment of one or more orthodontic brackets or orthodontic attachments on one or more teeth of a patient is provided, which method comprising steps a), a1), a2) a3) and b) as set forth in the aforementioned claims.

In the context of this embodiment, the term “prefilled” means that the at least one cavity or recess of the tray accommodates at least one bracket or attachment.

In one embodiment, the method comprises steps a), a1), a2), a3) b), c) and d)

According to one further embodiment of the invention, a transfer tray for the deployment of one or more orthodontic brackets or orthodontic attachments to one or more teeth of a patient is provided, said transfer tray comprising at least one cavity or recess that accommodates one such bracket or attachment, said transfer tray being manufactured with a method according to the above description.

According to one further embodiment of the invention, a method of deploying one or more orthodontic brackets or orthodontic attachments to one or more teeth of a patient is provided, in which method
a) a transfer tray, into the cavities of which one or more orthodontic brackets or attachments have been transferred according to claim 3, is arranged over a patient's gum or jaw ridge, or over a fragment thereof, and
b) one or more orthodontic brackets or orthodontic attachments are attached to one or more labial and/or palatal surfaces of the one or more teeth.

According to one embodiment, a dentition model comprising one or more tooth models is provided, which model has, on its labial and/or palatal surface, at least one bracket or attachment connected on its tooth-facing side to the tooth surface via at least one linker structure. The linker structure is embodied as a predetermined breaking point.

Preferably, such dentition model is produced with a CAM method according to the above description.

Preferably the dentition model further comprises a model of a patient's gum or jaw ridge, or of a fragment thereof, which supports the one or more tooth models.

According to one other aspect of the invention, a transfer tray for the deployment of one or more orthodontic brackets or orthodontic attachments to one or more teeth of a patient is provided, said transfer tray comprising
a section that is form-locking with at least a part of a crown of at least one tooth of a patient, and
at least one cavity or recess that accommodates or carries at least bracket or attachment,
   wherein the at least one bracket or attachment is connected the tooth-facing surface of the cavity or recess via at least one linker structure, which linker structure is embodied as a predetermined breaking point,

Before the transfer tray is arranged on the tooth, a curable resin is applied onto the tooth surface, or the tooth-facing side of the surface of the bracket or attachment. When the tray is arranged on the tooth, the bracket or attachment comes into contact with the tooth surface via the applied resin, which can then be cured. After the curable resin has been cured, the bracket or attachment remains attached to the tooth in the desired position. When the entire transfer tray is removed from the tooth, the linker structure, which is embodied as a predetermined breaking point, will break.

According to one embodiment of the invention, the section comprises
a first subsection suitable to be releasably attached to at least a part of a crown of at least one tooth of a patient, and
a second subsection which comprises the at least one cavity or recess that accommodates or carries the at least one bracket or attachment,
   wherein the two subsections are connected to one another by means of an integral hinge in such way that the second subsection can be flipped towards or away from the tooth.

The second subsection can hence be flipped away from the tooth. This allows to attach attaching a curable resin onto the tooth surface, or the tooth-facing side of the surface of the bracket or attachment. By flipping the second subsection back to the tooth the bracket or attachment comes into contact with the tooth surface via the applied resin, which can then be cured. After the curable resin has been cured, the bracket or attachment remains attached to the tooth in the desired position. When the second subsection is flipped away, or when the entire transfer tray is removed from the tooth, the linker structure, which is embodied as a predetermined breaking point, will break.

According to one further embodiment of the invention, the transfer tray has been created with a CAM method.

Such approach allows to create a transfer tray that has a respective section that is actually faithfully form-locking with at least a part of a crown of at least one tooth. Likewise, this approach allows to confer, to the attachment or bracket, almost any conceivable shape or form.

According to one embodiment of both aspects of the invention, the bracket or attachment has a tooth-facing side which is form-locking with the part of the tooth it is to be attached to.

Such form-locking surface can be accomplished because the bracket or attachment is preferably being formed with a CAM method. In such embodiment, the 3D shapes of the tooth facing side of the brackets can be highly individualized, thus being modeled as a negative to the surface shape of the section of the tooth to which they are meant to be deployed.

For example, if the tooth surface has a convex shape, the tooth facing side of the brackets or attachments has a concave shape which matches exactly with that of the tooth surface.

Usually, when non-individualized standard brackets or attachments are being used, the gaps between the tooth facing surfaces of the brackets or attachments and the tooth surfaces are being closed with excess application of curable resin.

The present method allows to individually adapt the tooth facing surfaces of the brackets or attachments to the tooth surfaces, hence avoiding the use of excess resin, and improving the physical connection between the brackets or attachments and the teeth.

According to another embodiment of both aspects of the invention, the CAM method is at least one selected from the group consisting of
CNC milling
Laser photolithography
stereolithography
3D printing

These methods are all nicknamed “rapid prototyping”, and can readily be applied by the skilled artisan, see e.g. Kumar and Ghafoor 2016. These methods use output data from CAD computer program according to standardized data formats. These methods encompass fused filament fabrication, selective laser sintering, direct metal laser sintering, selective laser melting, electron beam melting, inkjet 3D printing, laminated object manufacturing and the like.

According to another embodiment of both aspects of the invention, the bracket and/or attachment comprises a material selected from the group consisting of
PEEK (polyetheretherketon)
stainless steel
titanium

In general, all materials can be used that are suitable to be processed with any of the above identified CAM methods, provided they meet the requirements as regards stability, e-module biocompatibility and the like.

According to another embodiment of both aspects of the invention, at least one bracket or attachment comprises, on the side facing the surface of the tooth model, a microstructure.

Said microstructure facilitates the subsequent fixation of the brackets or attachments on the patient's tooth surface, by means of an adhesive, a cement or a curable resin.

Such microstructure can be a grating, a pattern of recesses, grooves, protrusions or ridges. Preferably, such microstructure is already introduced into the respective surface of the bracket and or attachment during the CAM manufacture process.

### REFERENCES

Kumar A, Ghafoor H. Rapid prototyping: A future in orthodontics. J Orthod Res 2016; 4:1-7
McNamara Jr, J A, Brudon W L. Invisible retainers. In: Orthodontic and orthopedic treatment in the mixed dentition. Mc Namara Jr, J A, Brudon W L. (1993) Seite 347-353
EP1143872A1

What is claimed is:

1. A method of producing one or more orthodontic brackets (2a) or attachments (2b), the method comprising
a) creating, by a CAM method, a dentition model (1a, 1b) comprising one or more tooth models (3), which model has, on its labial and/or palatal surface, at least one bracket (2a) or attachment (2b) connected on its tooth-facing side to the tooth surface via at least one linker structure (4), which linker structure is embodied as a predetermined breaking point.

2. The method according to claim 1, further comprising
b) releasing the one or more brackets or attachments from the tooth surface by breaking, cleaving or dissolving the linker structure.

3. A method for transferring one or more orthodontic brackets (2a) or attachments (2b) from a dentition model, to which they are connected by linker structure, into a transfer tray, the method comprising, after step a) and before step b) of claim 2, a step
a1.1) in which a transfer tray comprising a negative model (5) of the dentition model is created by forming or molding a matrix material over the dentition model including the one or more brackets or attachments, thereby forming cavities (6) which accommodate the brackets or attachments, or
a1.2) in which transfer tray comprising a prefabricated negative model (5) of the dentition model, which negative model comprises cavities (6) to accommodate the bracket or attachment, is arranged on the dentition model.

4. The method according to claim 3, wherein, after step a1.1) or a1.2.), a step
a2) is provided in which the transfer tray is removed from the dentition model, whereby the one or more brackets or attachments are released from the tooth surface by breaking, cleaving or dissolving the linker structure,
a3) in such way that they remain in the cavities formed in the negative model.

5. A method of transferring one or more orthodontic brackets (2a) or orthodontic attachments (2b) from a prefilled transfer tray as produced according to claims 3 and/or 4 to one or more teeth of a patient, said method comprising the steps of
c) arranging the transfer tray on one or more teeth of a patient, and
d) attaching the one or more brackets or attachments to the one or more tooth surfaces.

6. The method according to any one of claims 3-5, wherein the transfer is formed by vacuum forming of a thermoplastic sheet over the dentition model.

7. The method according to any of the above mentioned claims, wherein the dentition model further comprises a model of a patient's gum or jaw ridge (7), or of a fragment thereof, which supports the one or more tooth models.

8. A method of producing a prefilled transfer tray for the deployment of one or more orthodontic brackets or orthodontic attachments on one or more teeth of a patient, which method comprising steps a), a1), a2) a3) and b) as set forth in the aforementioned claims.

9. A transfer tray for the deployment of one or more orthodontic brackets or orthodontic attachments to one or more teeth of a patient, said transfer tray comprising at least one cavity or recess that accommodates one such bracket or attachment, said transfer tray being manufactured with a method according to claim 3, step a1.1)

10. A method of deploying one or more orthodontic brackets or orthodontic attachments to one or more teeth of a patient, in which method
a) a transfer tray, into the cavities of which one or more orthodontic brackets or attachments have been transferred according to claim 3, is arranged over a patient's gum or jaw ridge, or over a fragment thereof, and
b) one or more orthodontic brackets or orthodontic attachments are attached to one or more labial and/or palatal surfaces of the one or more teeth.

11. A dentition model (1a, 1b) comprising one or more tooth models (3), which model has, on its labial and/or palatal surface, at least one bracket (2a) or attachment (2b) connected on its tooth-facing side to the tooth surface via at least one linker structure (4), which linker structure is embodied as a predetermined breaking point.

12. A transfer tray for the deployment of one or more orthodontic brackets or orthodontic attachments (12) to one or more teeth (13) of a patient, said transfer tray comprising
a section (15) that is form-locking with at least a part of a crown of at least one tooth of a patient, and
at least one cavity or recess (16) that accommodates or carries at least bracket or attachment (12),
wherein the at least one bracket or attachment (12) is connected the tooth-facing surface of the cavity or recess (16) via at least one linker structure (14), which linker structure is embodied as a predetermined breaking point,

13. The transfer tray according to claim 12, wherein the section (15) comprises
a first subsection (15a) suitable to be releasably attached to at least a part of a crown of at least one tooth of a patient, and
a second subsection (15b) which comprises the at least one cavity or recess (16) that accommodates or carries the at least one bracket or attachment (12),
wherein the two subsections are connected to one another by means of an integral hinge (17), in such way that the second subsection (15b) can be flipped towards or away from the tooth (13).

14. The transfer tray according to any of claims 12-13, which transfer tray has been created with a CAM method.

15. The method according to any one of the aforementioned claims, wherein the bracket or attachment has a tooth-facing side which is form-locking with the part of the tooth it is to be attached to.

16. The method according to any of the above mentioned claims, wherein the CAM method is at least one selected from the group consisting of
CNC milling
Laser photolithography
stereolithography
3D printing

17. The method according to any of the above mentioned claims, wherein at least one bracket or attachment comprises, on the side facing the surface of the tooth model, a microstructure (8).
